(19) United States
(12) Patent Application Publication
(10) Pub. No.: US 2016/0072682 A1
(43) Pub. Date: Mar. 10, 2016

(54) DEVICE FOR MANAGING AND CONFIGURING FIELD DEVICES IN AN AUTOMATION INSTALLATION

(71) Applicant: ABB TECHNOLOGY AG, Zuerich (CH)

(72) Inventors: Dirk Wagener, Stadthagen (DE); Christoph Welte, Neu-Ulm (DE); Marcus Heeg, Kaisersesch (DE); Wolfgang Mahnke, Hettenleidelheim (DE); Marko Schlueter, Espelkamp (DE)

(21) Appl. No.: 14/847,017

(22) Filed: Sep. 8, 2015

(30) Foreign Application Priority Data
Sep. 8, 2014 (DE) 10 2014 013 259.5

(51) Int. Cl. H04L 12/24; H04L 29/08

(52) U.S. Cl. CPC H04L 41/22; H04L 41/0886; H04L 41/0806; H04L 67/34

(57) ABSTRACT

A device for managing and configuring field devices in an automation installation with a configuration tool which is operative to physically detect a field device in the automation installation, to logically incorporate it into the automation installation and to configure it in the automation installation, the configuration tool resorting for this purpose to a predefined first field-device-specific information packet which at least partially describes the functions and data of the field device and displays them in predefined screen elements. The configuration tool may be operative to individually arrange a plurality of screen elements of device-specific parameters, functions and/or graphical representations, which are predefined for display on a plurality of pages in the device-type-specific device description file, on a single device-specific page in an application-specific manner.

### CROSS-REFERENCE TO RELATED APPLICATIONS

Priority is claimed to German Patent Application No. DE 10 2014 013 259.5, filed on Sep. 8, 2014, the entire disclosure of which is hereby incorporated by reference herein.

### FIELD

The invention relates to a method and a device for managing and configuring field devices in an automation installation. The invention is used, in particular, in process automation or machine control for controlling processes and/or installation components.

### BACKGROUND

Automation systems for controlling a technical process or a technical installation usually comprise a control device (PLC) which is integrated in a group of a multiplicity of intelligent electrical devices. Intelligent electronic devices are microprocessor-based devices, for example protective and control devices, motor protective devices, intelligent switches and voltage regulators, frequency converters, pressure and temperature measuring transducers, flowmeters and actuators.

The article “FDI Device Integration—Best of Both Worlds”, atp edition June 2010, pages 16 to 19, discloses the practice of integrating field devices into an automation installation using the FDI concept (Field Device Integration IEC-62769). The basis of this concept is the provision of information for configuring field devices in a device-specific FDI packet. This FDI packet comprises a firmly predefined amount of information which consists of a device definition, business logic, a user interface description and user interface plug-ins. The device definition comprises management information and the device model. The business logic describes the communication logic for the device and is used to ensure consistency of the device model. The user interface description describes the presentation of the device parameters and device functions. The user interface plug-ins are programmed components of interface portions for displaying the device parameters and functions.

When configuring field devices by means of EDD (electronic device description) technology IEC 61804, a device manufacturer provides an EDD which comprises information relating to the communication with the device, the business logic and the user interfaces, that is to say which input masks should be displayed for a user. The business logic includes, for example, when which parameters can be written.

FDI technology uses these EDD mechanisms and provides the concept of the FDI package which, in addition to an EDD, may also include other information such as a user handbook or else so-called UIPs (user interface plug-in) which provide further user interfaces in other technologies, for example .NET assemblies, which, in contrast to EDD-based user interfaces, consist of programmed code compiled for a component.

FDI packets are typically created by device manufacturers and are used by system manufacturers to integrate and configure the devices from the device manufacturers in their system.

In addition to an individual user element having different parameters, graphs and other elements, new windows and dialogs may also be defined in the EDD. In this case, a host has certain freedoms and can display a plurality of menus defined in the EDD in different windows at the same time, for example, or else user interfaces of different device entities.

The field device manufacturer is generally responsible for creating and maintaining the EDD files. These EDD files describe, inter alia, how a user interface of a field device is represented. This described user interface is firmly defined and organized by the description in the EDD. The EDD files delivered are binary and therefore cannot be expanded.

The user of the field device configuration software does not have any option to adapt the user interface defined by EDD to his arrangements. He therefore has no control over which parameters, images or functions are arranged in which menu or on which page. Therefore, it is difficult for the user to make settings using only a few operations. On the basis of the individual work steps, the user needs a constantly recurring number of parameters, images or general settings to perform his task. Since the field device manufacturer creates the EDD file for a multiplicity of customers, he cannot go into the needs of an individual customer and therefore also cannot create the optimal user interface for a specific customer or user.

### SUMMARY

An aspect of the invention provides a managing and configuring device for one or more field devices in an automation installation with a configuration tool, wherein the managing and configuring device comprises: a unit configured to describe a predefined first field-device-specific information packet, wherein the configuration tool is operative to physically detect a field device in the automation installation, wherein the configuration tool is operative to logically incorporate the field device into the automation installation, wherein the configuration tool is operative to configure it in the automation installation, wherein the configuration tool resorts for this purpose to a predefined first field-device-specific information packet which at least partially describes functions and data of the field device, wherein the configuration tool displays the functions and date of the field device in predefined screen elements, and wherein the configuration tool is operative to individually arrange a plurality of screen elements of device-specific parameters, functions, and/or graphical representations, which are predefined for display on a plurality of pages in a device-type-specific device description file, on a single device-specific page in an application-specific manner.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a basic illustration of screen elements in the configuration tool from a device description file; and

FIG. 2 shows a basic illustration of screen elements in the configuration tool in an application-specific form.

### DETAILED DESCRIPTION

An aspect of the invention provides a device for managing and configuring field devices in an automation installation, which device allows device-specific parameters, functions and/or graphical representations to be individually represented in an application-specific manner in a clear form.

An aspect of the invention is based on an apparatus for managing and configuring field devices in an automation installation with a configuration tool which is operative to physically detect a field device in the automation installation, to logically incorporate it into the automation installation and to configure it in the automation installation, the configuration tool resorting for this purpose to a predefined first field-device-specific information packet which at least partially describes the functions and data of the field device and displays them in predefined screen elements.

According to an aspect of the invention, the configuration tool is operative to individually arrange a plurality of screen elements of device-specific parameters, functions and/or graphical representations, which are predefined for display on a plurality of pages in the device-type-specific device description file, on a single device-specific page in an application-specific manner.

Irrespective of the defined specification from the device description file, the user therefore advantageously finds all screen elements of device-specific parameters, functions and/or graphical representations on a single page in an application-specific manner in a clear form. This optimally supports the management and configuration of field devices in an automation installation for the respective application.

In one advantageous form of the invention, the configuration tool is operative to add structural elements, which go beyond the specification of the device-type-specific device description file, to the device-specific page which is individual in an application-specific manner.

In another advantageous form of the invention, the device-specific page which is individual in an application-specific manner is divided by the structural elements. Suitable dividing structural elements are known per se as tabs and the like. Such a division groups the screen elements of device-specific parameters, functions and/or graphical representations, which increases the clarity and user-friendliness of the configuration tool. In this case, application-specific and/or user-specific division of the screen elements results in an individual task-specific representation of the screen elements, which contributes to further improving the clarity and user-friendliness of the configuration tool.

In one advantageous form of the invention, the configuration tool is operative to create the device-specific page which is individual in an application-specific manner using an operator-guided pointer instrument from the multi-page representation which results from the defined specification from the device description file.

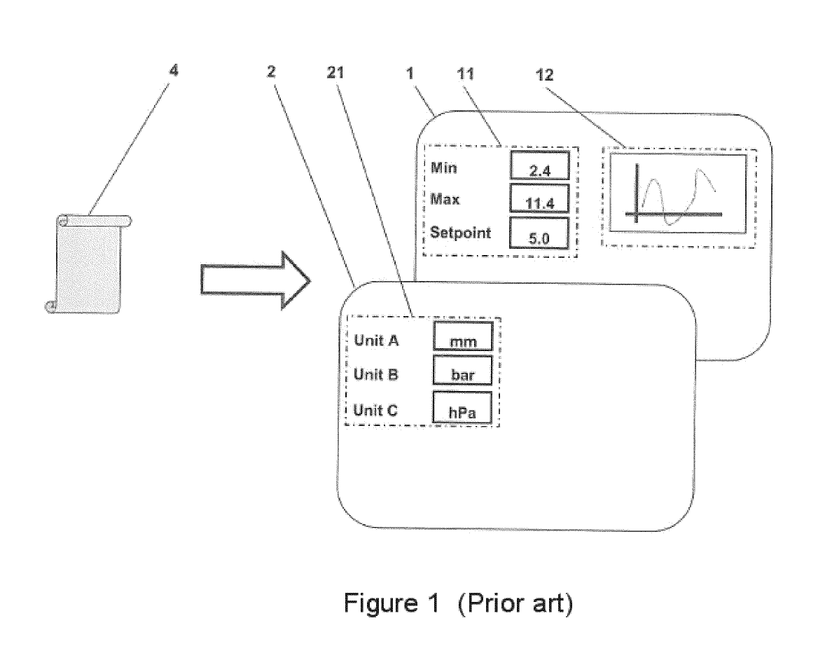

FIG. 1 is a basic illustration of the generation of visual screen elements 11, 12, 21 from a device description file 4 in a configuration tool according to the prior art. The device description file 4 is a binary device-type-specific EDD file which stores parameters, functions and/or graphical representations of a particular device type.

The device description file 4 is read into the configuration tool and visual screen objects are generated from its content according to the stored description. These screen objects are distributed among a plurality of pages 1, 2 in the form of screen elements 11, 12, 21. By way of example, the screen elements 11 and 12 are arranged on the page 1 and the screen element 21 is arranged on the page 2. In this case, each screen element 11, 12, 21 may be composed of a group of individual elements in the sense of this disclosure.

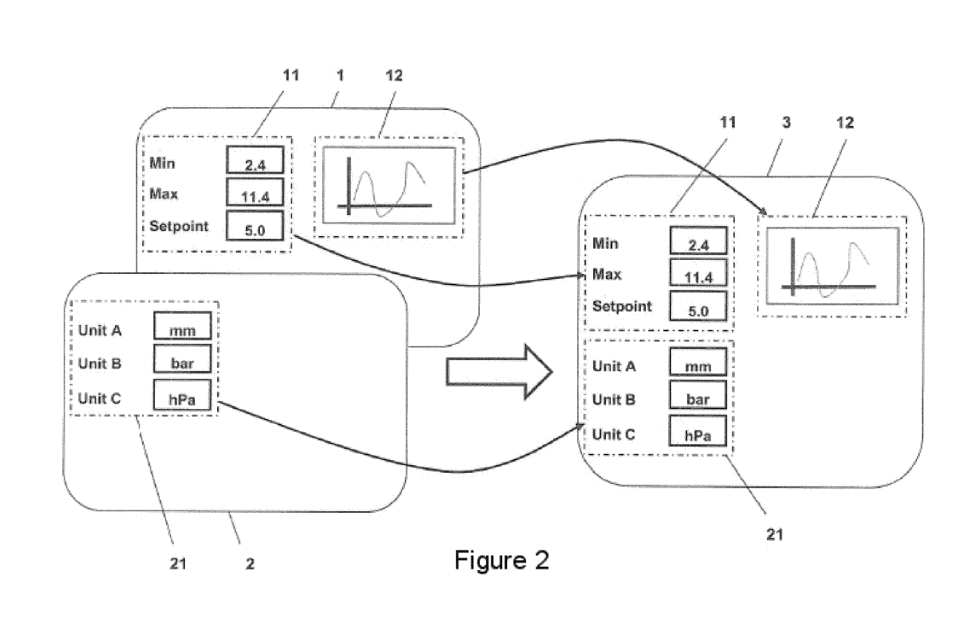

According to the invention, using the same reference symbols for the same means, the configuration tool according to FIG. 2 is operative to individually arrange the screen elements 11, 12, 21 in a combined manner on a single device-specific page 3 in an application-specific manner.

In one advantageous form of the invention, the configuration tool is operative to create the device-specific page 3 which is individual in an application-specific manner using an operator-guided pointer instrument by means of drag&drop from the multi-page representation 1, 2 which results from the defined specification from the EDD file 4.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE SYMBOLS

1, 2, 3 Page

11, 12, 21 Screen element

4 Device description file

1. A managing and configuring device for one or more field devices in an automation installation with a configuration tool, wherein the managing and configuring device comprises:
a unit configured to describe a predefined first field-device-specific information packet,
wherein the configuration tool is operative to physically detect a field device in the automation installation,
wherein the configuration tool is operative to logically incorporate the field device into the automation installation,
wherein the configuration tool is operative to configure it in the automation installation,
wherein the configuration tool resorts for this purpose to a predefined first field-device-specific information packet which at least partially describes functions and data of the field device,
wherein the configuration tool displays the functions and date of the field device in predefined screen elements, and
wherein the configuration tool is operative to individually arrange a plurality of screen elements of device-specific parameters, functions, and/or graphical representations, which are predefined for display on a plurality of pages in a device-type-specific device description file, on a single device-specific page in an application-specific manner.

2. The device of claim 1, wherein the configuration tool is operative to add structural elements, which go beyond a specification of the device-type-specific device description file, to the single device-specific page which is individual in an application-specific manner.

3. The device of claim 2, wherein the single device-specific page is individually divided by the structural elements.

4. The device of claim 1, wherein the configuration tool is operative to create the single device-specific page, which is individual, in an application-specific manner, using an operator-guided pointer instrument from the multi-page representation which results from a defined specification from a device description file.

5. The device of claim 1, wherein the configuration tool is operative to individually arrange a plurality of screen elements of device-specific parameters.

6. The device of claim 1, wherein the configuration tool is operative to individually arrange a plurality of screen elements of device-specific functions.

7. The device of claim 5, wherein the configuration tool is operative to individually arrange a plurality of screen elements of device-specific functions.

8. The device of claim 1, wherein the configuration tool is operative to individually arrange a plurality of screen elements of device-specific graphical representations.

9. The device of claim 5, wherein the configuration tool is operative to individually arrange a plurality of screen elements of device-specific graphical representations.

10. The device of claim 6, wherein the configuration tool is operative to individually arrange a plurality of screen elements of device-specific graphical representations.

11. The device of claim 7, wherein the configuration tool is operative to individually arrange a plurality of screen elements of device-specific graphical representations.
